(19) United States
(12) Patent Application Publication
(10) Pub. No.: US 2015/0381831 A1
(43) Pub. Date: Dec. 31, 2015

(54) IMAGE PROCESSING APPARATUS, SCREEN DISPLAY METHOD FOR THE SAME, AND RECORDING MEDIUM

(71) Applicant: KONICA MINOLTA, INC., Chiyoda-ku, Tokyo (JP)

(72) Inventors: Yusuke SHINOSAKI, Toyokawa-shi (JP); Yoichi KURUMASA, Toyokawa-shi (JP); Mie KAWABATA, Toyokawa-shi (JP); Hiroaki SUGIMOTO, Nagoya-shi (JP); Shohei ICHIYAMA, Toyokawa-shi (JP)

(73) Assignee: KONICA MINOLTA, INC., Chiyoda-ku, Tokyo (JP)

(21) Appl. No.: 14/746,073

(22) Filed: Jun. 22, 2015

(30) Foreign Application Priority Data
Jun. 25, 2014 (JP) 2014-129897

(51) Int. Cl. H04N 1/00

(52) U.S. Cl. CPC H04N 1/00352

(57) ABSTRACT

An image processing apparatus includes a display and one or a plurality of processors that executes the following processes: determining one of a plurality of screen switch groups as a search target, the plurality of screen switch groups each being composed of a plurality of multi-level screens, the multi-level screens to be displayed on the display; obtaining strings by searching the determined screen switch group, the strings each having a keyword specified by the user, the strings representing setting options to be set on the multi-level screens, the multi-level screens composing the determined screen switch group; and displaying the setting options on the display in a manner allowing the user to select one of the setting options, the setting options being represented by the obtained strings, and then displaying a screen for setting one of the setting options upon the one setting option being selected by the user.

This application claims priority under 35 U.S.C. §119 to Japanese Patent Application No. 2014-129897 filed on Jun. 25, 2014, the entire disclosure of which is incorporated herein by reference in its entirety.

### BACKGROUND OF THE INVENTION

1. Field of the Invention

The present invention relates to an image processing apparatus such as a multifunctional digital image forming apparatus (i.e., a multi-function peripheral abbreviated as MFP) having printer function, facsimile function, scanner function, and other functions, a screen display method for the image processing apparatus, and a non-transitory computer-readable recording medium.

2. Description of the Related Art

The following description sets forth the inventor's knowledge of related art and problems therein and should not be construed as an admission of knowledge in the prior art.

Latest image processing apparatuses as represented by MFPs as mentioned above have many feasible functions being installed. In order to use such a feasible function, users need to press a function button on an operation panel to go to a lower-level settings screen for the function and then further press a desired function button thereon to go to a still lower-level settings screen for the function. That is, latest image processing apparatuses are configured to display screens in a multi-level hierarchical manner.

In order to allow users to go to their intended screen quickly, suggested are image processing apparatuses which are configured to display screens in a multi-level hierarchical manner as described above; the image processing apparatuses search dictionary data with a keyword entered by users, obtain and display relevant setting options, and display a settings screen for one of the setting options quickly when it is selected by a user (Japanese Unexamined Patent Publication No. 2009-093312).

These image processing apparatuses display search results regardless of the screen presently opened by users and the frequency of use, which causes the inconvenience that users may accidentally go to a screen having no bearing on their desired function. Specifically, if these are MFPs for example, the MFPs switch from one screen to another in descending order of level when a user selects a main function such as copier function, scanner function, or box function on a menu screen. When the user conducts search on a screen for copier function, for example, intending to go to a lower-level settings screen for copier function, the MFPs may possibly display setting options for scanner function at high positions in a list, as search results, which causes the inconvenience that users may accidentally go to an unintended screen by selecting one of them.

Meanwhile, suggested is a technique of extracting specific strings from keywords used for search, ranking them on the basis of the number of times they are used for search, and displaying search results being listed in an order based on the ranking (Japanese Unexamined Patent Publication No. 2008-158893). This technique allows the image processing apparatuses to display search results being listed in an order based on the frequency of use and quickly switch to a screen most likely intended by users.

This technique, which is described in Japanese Unexamined Patent Publication 2008-158893, however, does not bring a perfect solution to the inconvenience that users may accidentally go to an unintended screen.

In an environment where copier function is used frequently, when a user conducts search with the keyword “density” on a scanner function screen, for example, intending to go to a settings screen for density of scanner function, density setting options for copier function are displayed at high positions in a list, as search results, since copier function is used more frequently. This causes the inconvenience that users may accidentally go to a density settings screen of copier function, not that of scanner function as originally intended, by selecting one of them.

The same is also true for a case where an administrator intends to go to an administrator settings screen. When an administrator conducts search with the keyword “density” on an administrator screen, intending to go to a “toner density adjustment” screen of administrator function, density setting options for administrator function are displayed at low positions in a list, as search results, since administrator function is used less frequently. This causes the inconvenience that an administrator may accidentally go to an unintended settings screen.

### SUMMARY OF THE INVENTION

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

A first aspect of the present invention relates to an image processing apparatus including:

a display; and

one or a plurality of processors that executes:

determining one of a plurality of screen switch groups as a search target based on a screen being displayed when a user gives instructions to search, the plurality of screen switch groups each being composed of a plurality of multi-level screens, the multi-level screens to be displayed on the display;

obtaining strings by searching the determined screen switch group, the strings each having a keyword specified by the user, the strings representing setting options to be set on the multi-level screens, the multi-level screens composing the determined screen switch group; and

displaying the setting options on the display in a manner allowing the user to select one of the setting options, the setting options being represented by the obtained strings, and then displaying a screen for setting one of the setting options upon the one setting option being selected by the user.

A second aspect of the present invention relates to a screen display method for an image processing apparatus including one or a plurality of processors that execute:

determining one of a plurality of screen switch groups as a search target based on a screen being displayed when a user gives instructions to search, the plurality of screen switch groups each being composed of a plurality of multi-level screens, the multi-level screens to be displayed on the display;

obtaining strings by searching the determined screen switch group, the strings each having a keyword specified by the user, the strings representing setting options to be set on the multi-level screens, the multi-level screens composing the determined screen switch group; and

displaying the setting options on the display in a manner allowing the user to select one of the setting options, the setting options being represented by the obtained strings, and then displaying a screen for setting one of the setting options upon the one setting option being selected by the user.

A third aspect of the present invention relates to a non-transitory computer-readable recording medium storing a screen display program for a computer of an image processing apparatus including a display, the screen display program making the computer execute:

determining one of a plurality of screen switch groups as a search target based on a screen being displayed when a user gives instructions to search, the plurality of screen switch groups each being composed of a plurality of multi-level screens, the multi-level screens to be displayed on the display;

obtaining strings by searching the determined screen switch group, the strings each having a keyword specified by the user, the strings representing setting options to be set on the multi-level screens, the multi-level screens composing the determined screen switch group; and

displaying the setting options on the display in a manner allowing the user to select one of the setting options, the setting options being represented by the obtained strings, and then displaying a screen for setting one of the setting options upon the one setting option being selected by the user.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying drawings, in which:

FIG. 1 is a block diagram illustrating a system configuration of an image processing apparatus according to one embodiment of the present invention;

FIG. 2A is an exterior perspective view of the image processing apparatus; FIG. 2B is a front view of an operation panel of the image processing apparatus;

FIG. 3 illustrates a frame format for explaining how the screen is switched when copier function, facsimile/scanner function, and box function, for example, are selected on a menu screen;

FIG. 4 illustrates a search screen;

FIG. 5 is a flowchart representing a process of switching the screen when keyword search is conducted;

FIG. 6 is a view for explaining that there is one search portion and one database are provided for each screen switch table;

FIG. 7 illustrates a screen on which search results are displayed;

FIG. 8 is a flowchart representing a search process to be implemented in another embodiment of the present invention;

FIG. 9 is a table containing information about strings representing setting options to be set on the screens from all screen switch groups;

FIG. 10 is a flowchart representing a search process to be implemented in yet another embodiment of the present invention;

FIG. 11 is a flowchart representing a search process to be implemented in still yet another embodiment of the present invention;

FIGS. 12A to 12C are views for explaining that a lower-level screen is displayed in partial-screen and in full-screen;

FIG. 13 is a view for explaining that a screen switch group is created in another screen switch group;

FIG. 14 is a view for explaining how a screen switch group is created;

FIG. 15 is a view for explaining how a search range is specified in a case where a screen switch group is created in another screen switch group;

FIGS. 16A to 16C are views for explaining a mode for displaying an intended screen by switching from one screen to another in descending order of level; and

FIG. 17 illustrates a screen on which strings representing setting options are displayed in a highlighted manner.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, some embodiments of the present invention will be described with reference to the accompanying drawings.

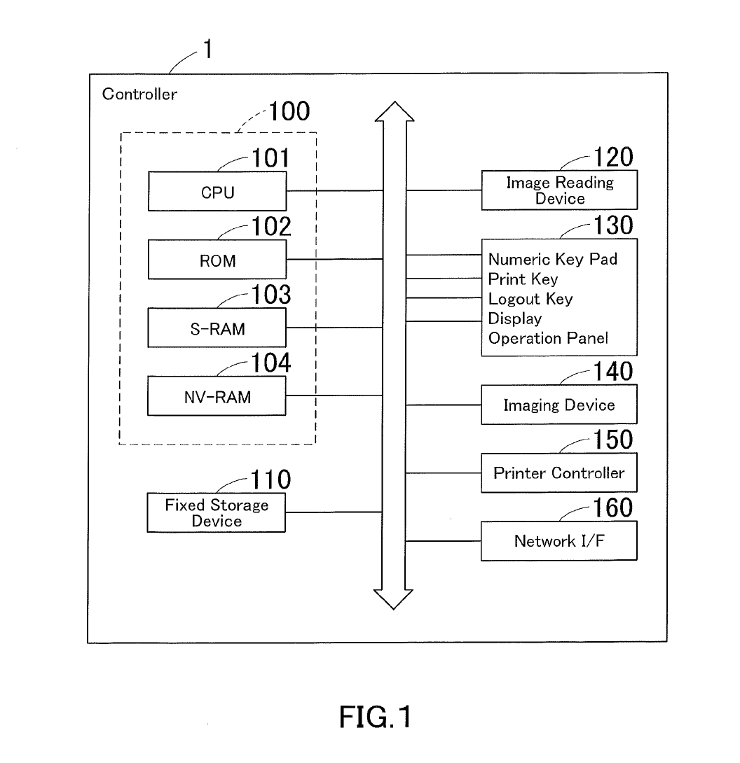

FIG. 1 is a block diagram illustrating a system configuration of an image processing apparatus according to one embodiment of the present invention. In this embodiment, a MFP, i.e., a multifunctional digital image forming apparatus as described above, is employed as an image processing apparatus 1.

As illustrated in FIG. 1, the image processing apparatus 1 is provided with a controller 100; the controller 100 is composed of the following elements: a CPU 101 for controlling the image processing apparatus 1 in a unified manner; a RAM 102 for storing programs for control; a static random access memory (S-RAM) 103 for working of CPU 101; and a non-volatile memory (NV-RAM) 104 that is a battery backup storage storing various image forming settings, all of which are connected to each other via a bus network. The number of the CPUs 101 is not limited to only one; a plurality of the CPUs 101 may be provided thereon.

The controller 100 is connected to the following portions via the bus network: an image reading device 120 for reading images on a document; an operation panel 130 being provided with a display and various keys such as a numeric keypad, a print key, and a logout key, for user inputs; a network interface 160 for supporting information exchange with external apparatuses such as information processing apparatuses connected through a network; a printer controller 150 for forming toner images from print data received by the network I/F 160; and an imaging device 140 for transferring toner images onto paper.

The controller 100 is also connected to a fixed storage device 110 via the bus network. The fixed storage device 110 is a hard disk drive, for example; the fixed storage device 110 stores various data objects.

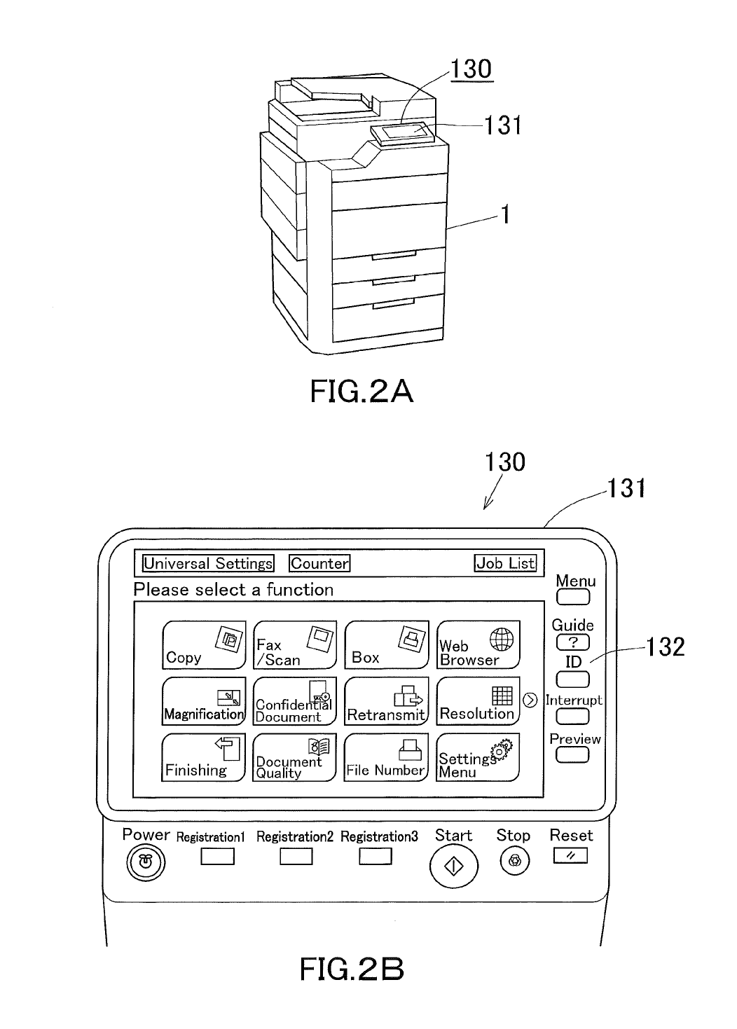

The operation panel 130 is positioned at the upper part of the front of the image processing apparatus 1 and is provided with the display 131 as illustrated in FIG. 2A. The display 131 is provided with a touch panel that allows gesture-based input; the display 131 displays, as well as various messages for users, settings screens allowing users to make various settings to use functions of the image processing apparatus 1.

As illustrated in FIG. 2B, a menu screen 132 having function buttons representing various functions such as copier function, facsimile/scanner function, box function, and web browser function is displayed on the display 131 as an initial screen. When a user presses one of the buttons, the screen is switched to a lower-level screen allowing the user to make detailed settings.

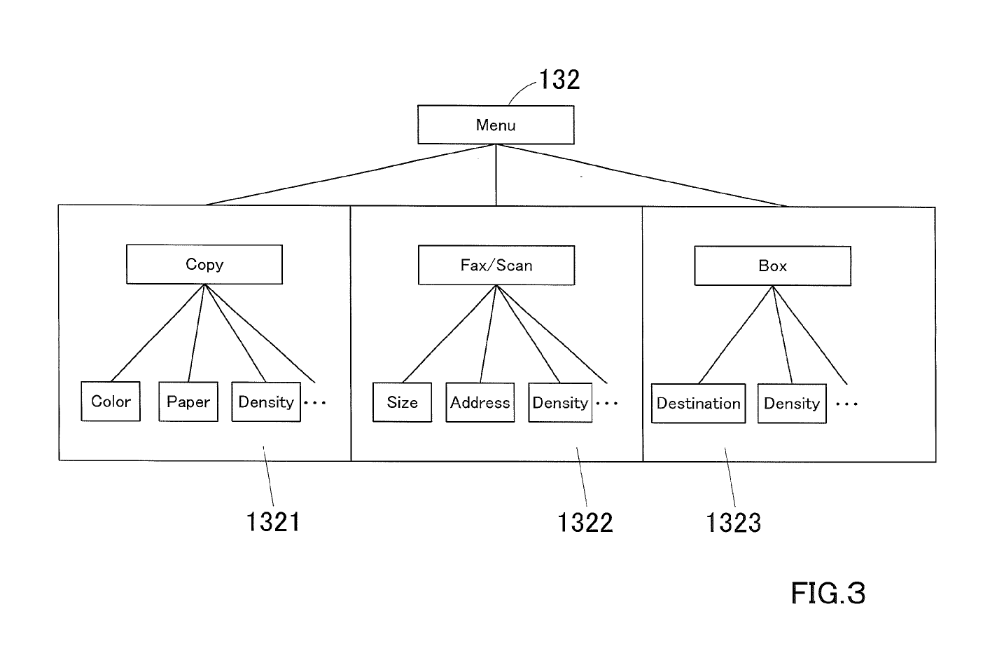

FIG. 3 illustrates a frame format for explaining how the screen is switched when copier function, facsimile/scanner function, and box function, for example, are selected on the menu screen 132.

When a user selects copier function on the menu screen 132, the screen is switched to a screen 1321. The screen 1321 allows the user to select color, paper, density, or other setting options by pressing a button.

When a user selects facsimile/scanner function on the menu screen 132, the screen is switched to a screen 1322. The screen 1322 allows the user to select size, address, density, or other setting options by pressing a button.

When a user selects box function on the menu screen 132, the screen is switched to a screen 1323. The screen 1323 allows the user to select destination, density, or other setting options by pressing a button. Box function is a function for storing document files in a predetermined memory area of the fixed storage device 110, which is referred to as box, and for outputting the document files therefrom.

When the user selects a setting option by pressing a button on the screens 1321 to 1323, the screen is switched to a lower-level settings screen allowing the user to make settings as necessary. The user may further selects a setting option by pressing a button on that settings screen, intending to go to a still lower-level settings screen.

In this embodiment, when a user selects a setting option by pressing a button on the menu screen 132, the screen is switched to the screens 1321 to 1323, each of which is a node at the top level of one screen switch group that is composed of multi-level screens. That is, there is one screen switch group for each of the functions such as copier function, facsimile/scanner function, and box function.

Furthermore, in this embodiment, the user is allowed to enter a search keyword in order to find his/her intended screen from multi-level screens and go there quickly. For example, when the user swipes the copier function screen 1321 on the display 131, a search screen having a search box 131a and a software keyboard 131b is displayed, which allows the user to enter a keyword in the search box 131a and conduct search with the keyword. It should be understood that the user does not necessarily swipe the copier function screen 1321 to show a search screen; alternatively, the user may press a search button displayed thereon, for example, to show a search screen.

In this embodiment, keyword search is conducted on one of the above-described screen switch groups to which the screen displayed on the display 131 when the user gives instructions to search belongs.

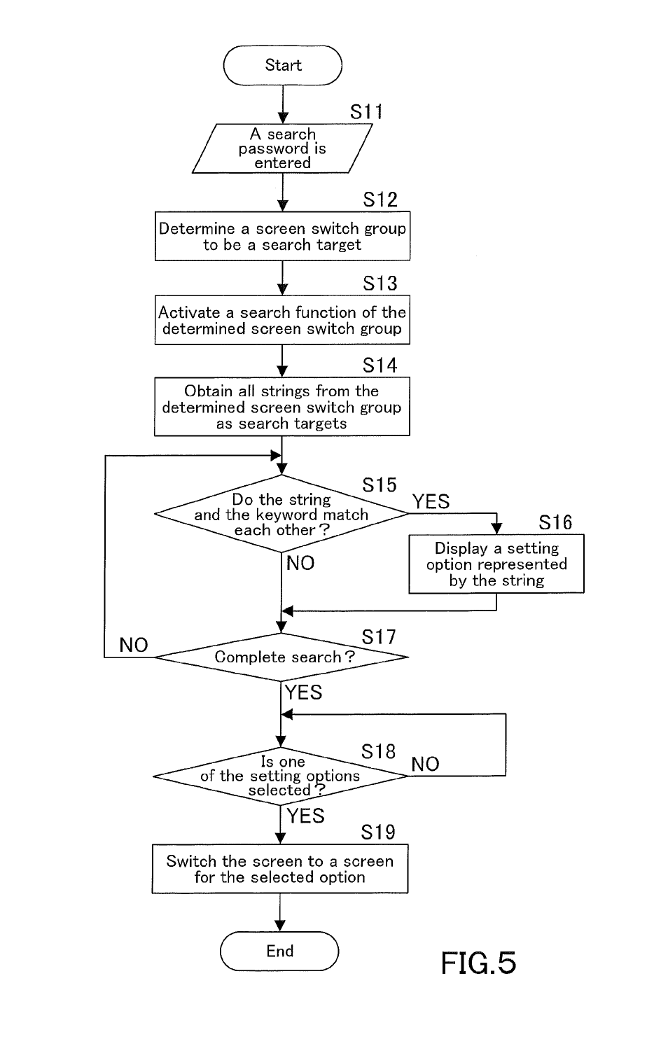

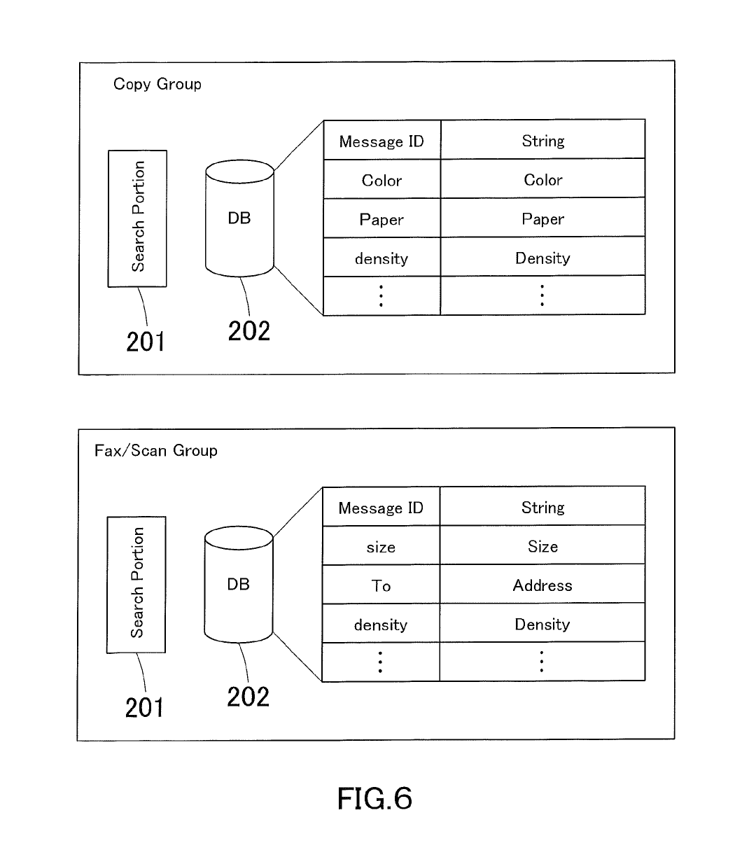

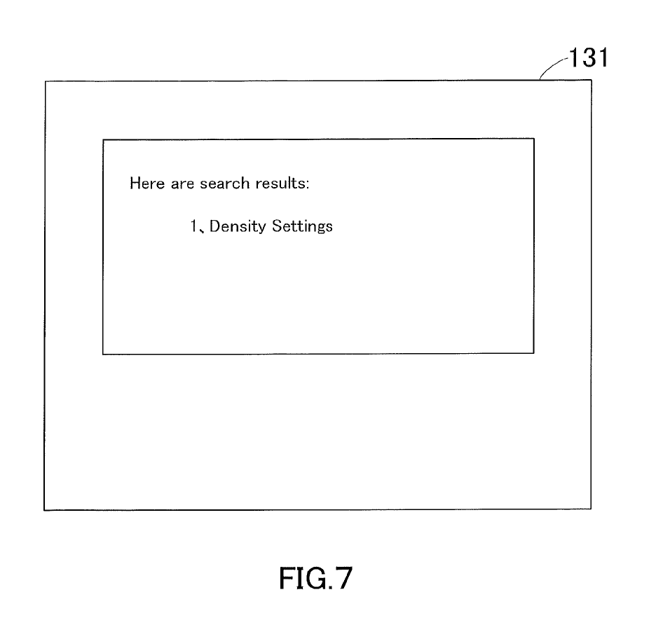

FIG. 5 is a flowchart representing a process of switching the screen when keyword search is conducted. The routines represented by the FIG. 5 flowchart and the following flowcharts are executed by the CPUs 101 of the image processing apparatus 1 in accordance with operation programs stored on a recording medium such as the ROM 102.

In the example of FIG. 5, one search portion (search function) 201 and one database (referred to as DB in this FIG. 202 are provided for each of the screen switch groups for copier function, facsimile/scanner function, box function, and other functions. Each search portions 201 is achieved by one the CPU 101; that is, the search functions, i.e., the search portions 201 are achieved by a plurality of the CPUs 101, respectively.

Each database 202 stores strings representing setting options to be set on the screens from one of the screen switch groups while each of the strings is associated with one message ID that is unique identification information. For example, the string “density” representing a density setting option is associated with the message ID “density”. Although it is not shown in this figure, each screen is also associated with one message ID and any settings screen for setting options represented by strings can be identified thereby.

A user enters a search keyword on a search screen; the keyword is accepted in Step S11 of FIG. 5 and a screen switch group is determined to be a search target in Step S12. In this embodiment, as mentioned above, a screen switch group to which the screen displayed on the display 131 when the user gives instructions to search belongs is determined to be a search target.

In Step S13, the search portion 201 for the determined screen switch group is activated; in Step S14, all strings are obtained from the database 202 for the determined screen switch group, as search targets.

Subsequently, in Step S15, the first string is compared to the keyword entered by the user and it is judged whether or not they match each other. If they match each other (YES in Step S15), a setting option represented by the string is displayed in Step S16, the routine then proceeds to Step S17. For example, if the string and the keyword match each other and they are “density”, the “density” setting option is displayed on the display 131 along with a message introducing search results. If they do not match each other (NO in Step S15), the routine then proceeds to Step S17 in a direct manner.

In Step S17, it is judged whether or not search is completed, in other words, whether or not there is another string to be compared. If search is not completed yet (NO in Step S17), the routine returns to Step S15 to compare another string to the keyword. If search is completed and all the strings are already compared (YES in Step S17), it is judged in Step S18 whether or not the user selects one of the setting options on the screen. It should be understood that, when two or more strings are obtained with one keyword as search results, setting options represented by these strings, respectively, are displayed on the display 131.

If the user does not select any of the setting options (NO in Step S18), the routine waits until the user selects one of the setting options. If the user selects a desired one of the setting options with a touch or another gesture (YES in Step S18), the screen is switched to a settings screen for the selected setting option, e.g., a density settings screen, in Step S19.

As described above, in this embodiment, search is conducted with a keyword only on a screen switch group to which the screen presently opened by the user belongs, in other words, only on a screen switch group having bearing on the function intended by the user. For example, when the user uses copier function, search is conducted with a keyword only on the multi-level screens having bearing on copier function, and a string representing a setting option of scan function is not obtained by search even if the string matches the keyword. This allows users to go to their intended settings screen quickly without the inconvenience that they may accidentally go to an unintended screen by selecting a setting option of a function that is not used by them.

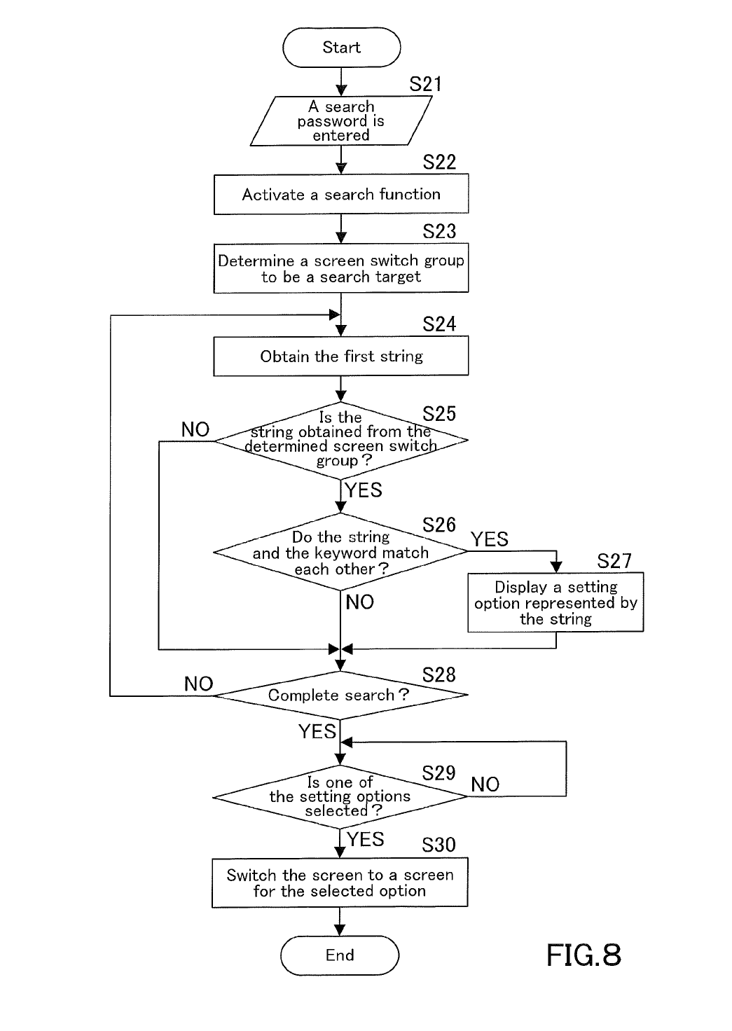

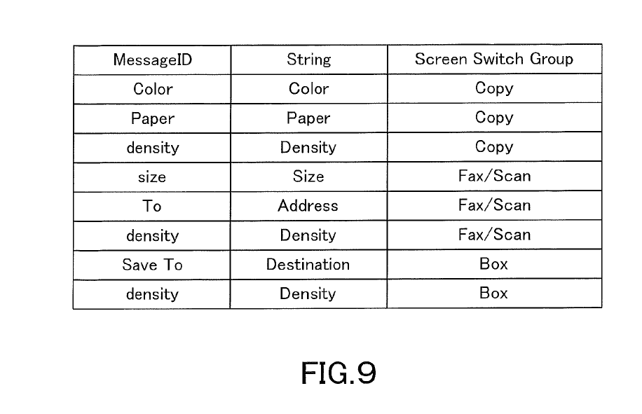

FIG. 8 is a flowchart representing a search process to be implemented in another embodiment of the present invention. In this example, instead of one search function for each screen switch group, one common search portion 201 is provided for all screen switch groups. That is, search is conducted on all screen switch groups by the CPU 101 that is one common CPU for all the screen switch groups. There is also one common database for all screen switch groups; as shown in FIG. 9, the database records a table containing information about strings representing setting options to be displayed on the screens from all screen switch groups.

A user enters a search keyword on a search screen; the keyword is accepted in Step S21 of FIG. 8 and search function is activated in Step S22. Subsequently, in Step S23, a screen switch group to which the screen displayed on the display 131 when the user gives instructions to search belongs is determined to be a search target.

In Step S24, the first string is obtained from the database 202; in Step S25, it is judged whether or not the string is obtained from the screen switch group determined in Step S23. If it is not obtained from the screen switch group (NO in Step S25), the routine then proceeds to Step S28. If it is obtained from the screen switch group (YES in Step S25), it is judged in Step S26 whether or not the string and the keyword entered by the user match each other.

If they match each other (YES in Step S26), a setting option represented by the string is displayed in Step S27, the routine then proceeds to Step S28. If they do not match each other (NO in Step S26), the routine then proceeds to Step S28 in a direct manner.

In Step S28, it is judged whether or not search is completed, in other words, whether or not there is another string to be compared. If search is not completed yet (NO in Step S28), the routine returns to Step S24 to obtain another keyword then repeats Step S25 to S28. If search is completed and all the strings are already compared (YES in Step S28), it is judged in Step S29 whether or not the user selects one of the setting options on the screen.

If the user does not select any of the setting options (NO in Step S29), the routine waits until the user selects one of the setting options. If the user selects a desired one of the setting options with a touch or another gesture (YES in Step S29), the screen is switched to a settings screen for the selected setting option in Step S30.

As described above, in this embodiment, keyword search is conducted only on a screen switch group to which the screen presently opened by the user belongs, in other words, only on a screen switch group having bearing on the function intended by the user. The search results do not include setting options for a function that is not used by the user, even if strings representing the setting options match the keyword. This allows users to go to their intended settings screen quickly without the inconvenience that they may accidentally go to an unintended screen by selecting a setting option of a function that is not used by them.

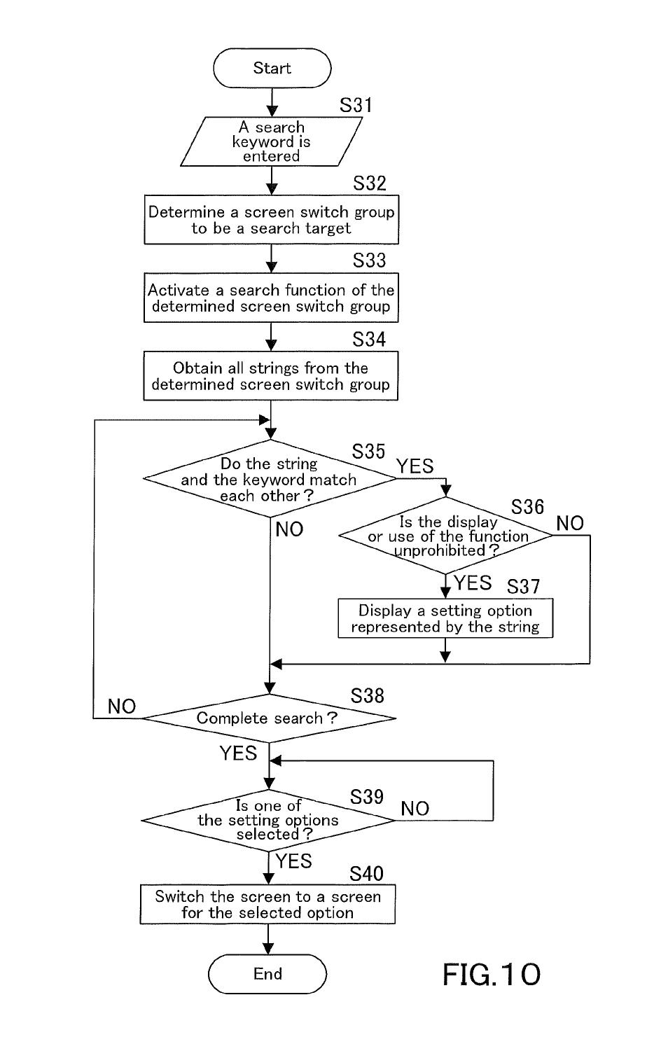

FIG. 10 is a flowchart representing a search process to be implemented in yet another embodiment of the present invention. In this embodiment, search is conducted in a case where a function having a setting option represented by a string is prohibited from being displayed or used. For example, when the settings of server message block (SMB) is “enabled” (“unprohibited”), a SMB settings screen is displayed; when it is “disabled” (“prohibited”), a SMB settings screen is not displayed. In the example of FIG. 10, there are one search portion 201 and one database 202 for each of the screen switch groups; alternatively, it should be understood, as a matter of course, that there may be one common search portion 201 and one common database 202 for all the screen switch groups.

A user enters a search keyword on a search screen; the keyword is accepted in Step S31 of FIG. 10 and a screen switch group is determined to be a search target in Step S32.

In Step S33, the search portion 201 for the determined screen switch group is activated; in Step S34, all strings are obtained from the database 202 for the determined screen switch group, as search targets.

Subsequently, in Step S35, the first string is compared to the keyword entered by the user and it is judged whether or not they match each other. If they match each other (YES in Step S35), it is judged in Step S36 whether or not the display or use of a function having a setting option represented by the string is unprohibited. If it is unprohibited (YES in Step S36), a setting option represented by the string is displayed in Step S37, the routine then proceeds to Step S38. If the display or use is prohibited (NO in Step S36), the routine then proceeds to Step S38 in a direct manner. Back to Step S35, if the string and the keyword do not match each other (No in Step S35), the routine then proceeds to Step S38.

In Step S38, it is judged whether or not search is completed, in other words, whether or not there is another string to be compared. If search is not completed yet (NO in Step S38), the routine returns to Step S35 to compare another string to the keyword. If search is completed and all the strings are already compared (YES in Step S38), it is judged in Step S39 whether or not the user selects one of the setting options on the screen.

If the user does not select any of the setting options (NO in Step S39), the routine waits until the user selects one of the setting options. If the user selects a desired one of the setting options with a touch or another gesture (YES in Step S39), the screen is switched to a settings screen for the selected setting option in Step S40.

As described above, setting options for a function prohibited from being displayed or used are not displayed even if strings representing the setting options match the keyword. This allows users to avoid selecting a setting option of a prohibited function.

Users may need to obtain setting options of all functions even in a case where there is a function prohibited from being displayed or used; users may need to obtain setting options of only unprohibited functions. As a solution to this, users may make settings, before search, such that strings representing setting options of a function prohibited from being displayed or used will or will not be obtained by search.

In a case where a user makes settings such that a string representing a setting option of a function prohibited from being displayed or used will be obtained by search, the setting option represented by the string will be displayed as a search result. The user, however, cannot go to a settings screen for the prohibited function by selecting the setting option.

As a solution to this, when a user selects a setting option of a function prohibited from being displayed or used, it is preferred that a settings screen for removing the prohibition against the display or use of the selected setting option, instead of a settings screen for the selected setting option.

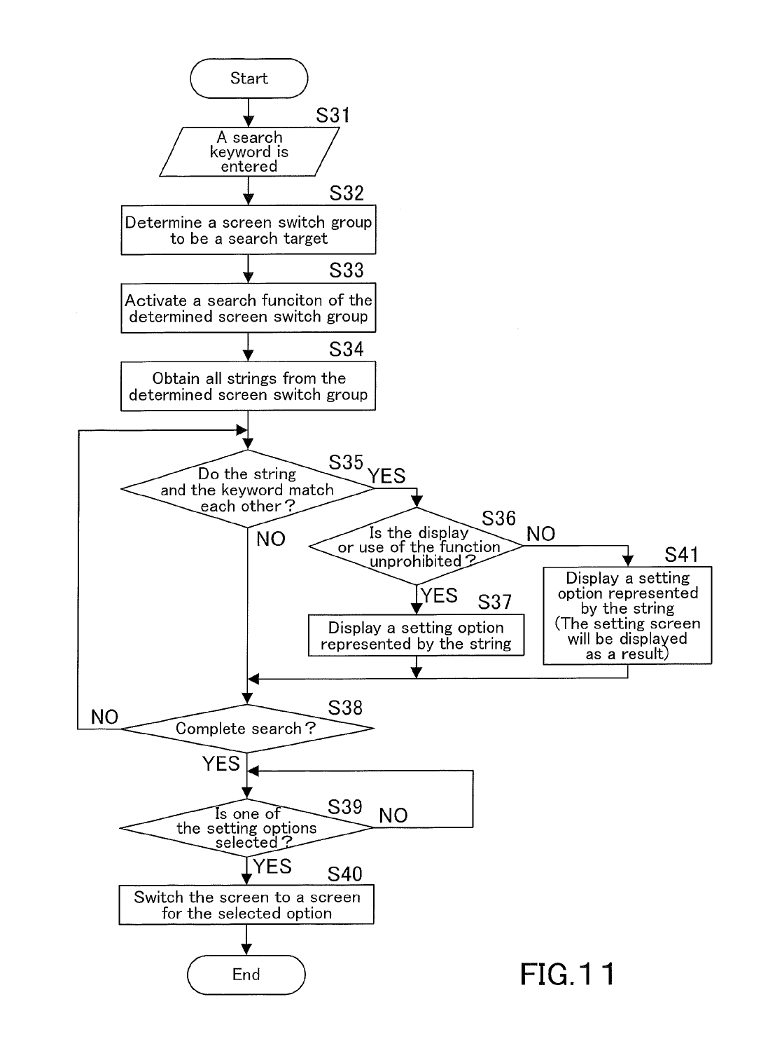

FIG. 11 is a flowchart representing such a process as described above. The flowchart of FIG. 11 is only slightly different from that of FIG. 10 because of the presence of Step S41, which is guided with the option “NO” in Step S36 where it is judged whether or not the display or use is prohibited. That is, if the display or use is prohibited (NO in Step S36), a setting option represented by the string is displayed on the display 131 in Step S41, the routine then proceeds to Step S38. If the user selects this setting option in Step S39, a settings screen for removing the prohibition against the display or use is displayed in Step S40. The user can change the settings on the settings screen. Instead of a settings screen for removing the prohibition against the display or use, a message advising how to change the settings may be displayed.

In a case where a specific user having power, such as an administrator, makes settings such that a string representing a setting option of a function prohibited from being displayed or used will be obtained by search, it is preferred that the setting option represented by the string be not displayed in order to protect the settings, even if the string matches a keyword. In a different case where a specific user having power prohibits a function from being displayed or used, settings may be automatically made such that a string representing a setting option of the prohibited function will not be obtained by search.

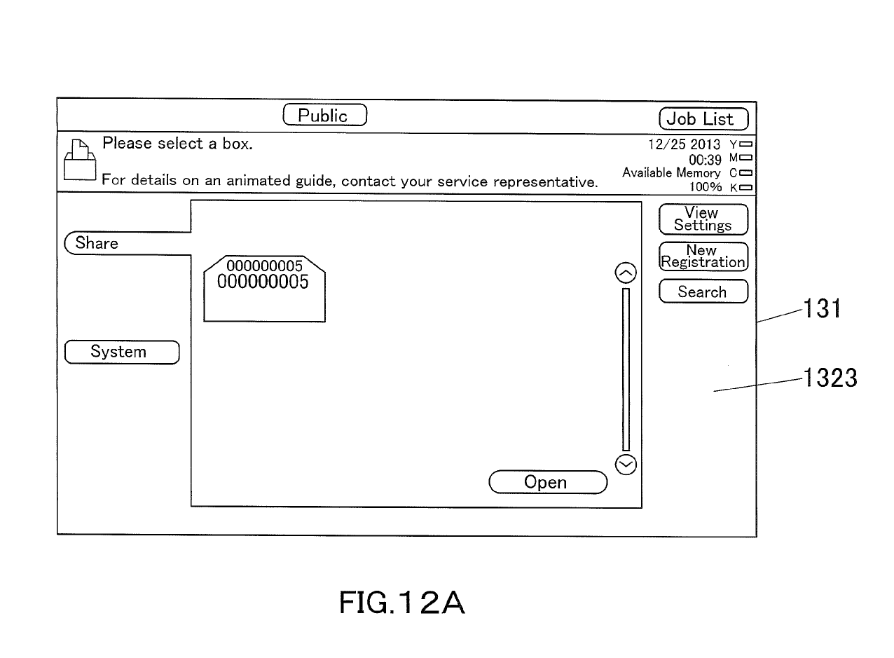

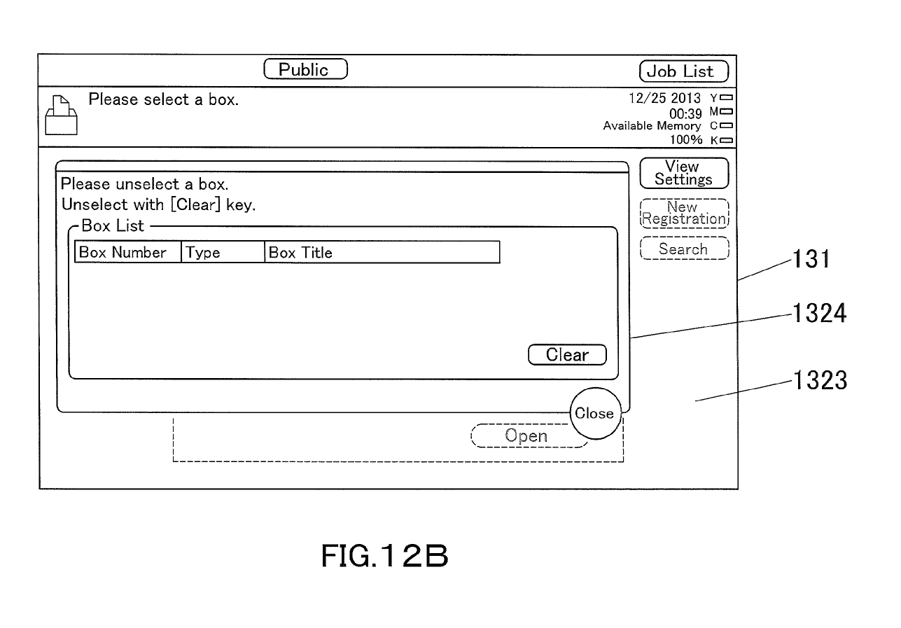

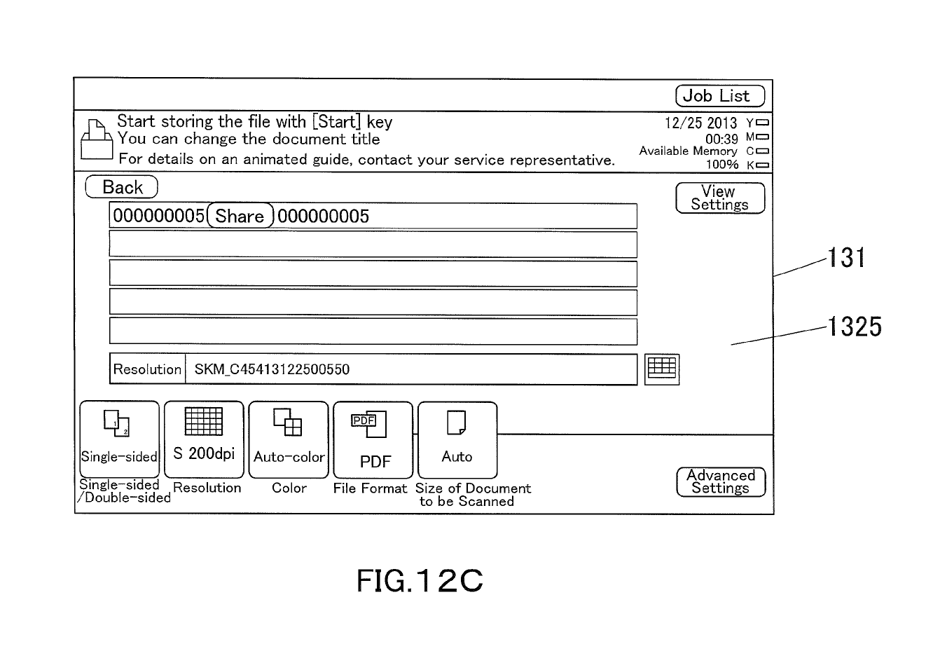

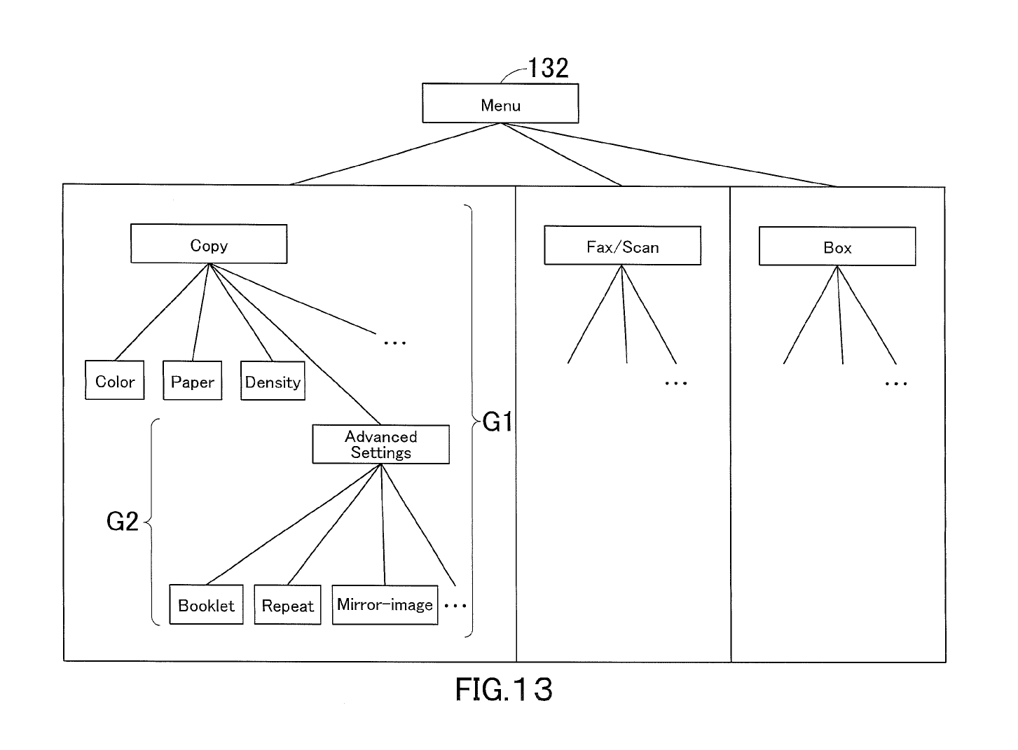

In another embodiment, when a user presses a settings button for function settings, a lower-level screen may be displayed in partial-screen, in a pop-up manner, or may be displayed in full-screen. For example, when a user presses a box function button on the menu screen, the screen is switched to a screen 1323 as illustrated in FIG. 12A; when the user further presses a “view settings” button on the screen 1323, a screen 1324 showing information about the box presently used is displayed in partial-screen on the screen 1323, in a pop-up manner, as illustrated in FIG. 12B. Alternatively, when the user further presses a “new registration” button on the screen 1323 of FIG. 12A, a lower-level screen 1325 is displayed in full-screen in a sliding manner as illustrated in FIG. 12C. It should be understood that screens are displayed on the display 131 in a multi-level hierarchical manner also in both cases where a lower-level screen is displayed in partial-screen and where a lower-level screen is displayed in full-screen.

In this embodiment, a screen switch group can be created as instructed by users. That is, when a user selects copier function on the menu screen 132, the screen is switched to another screen which may have an “advanced settings” button as well as color settings button, paper settings button, density settings button, and other buttons. This is an advanced settings screen having many setting options such as booklet, repeat, and mirror-image and there is a lower-level settings screen for each of the setting options. A screen switch group composed of multi-level screens can be created such that the advanced settings screen is a node at the top level. Specifically, a screen switch group G2 that is composed of multi-level screens can be created at a level lower than a screen switch group G1 that is composed of multi-level screens for copier function. This allows users to find a desired setting option quickly from well-targeted setting options.

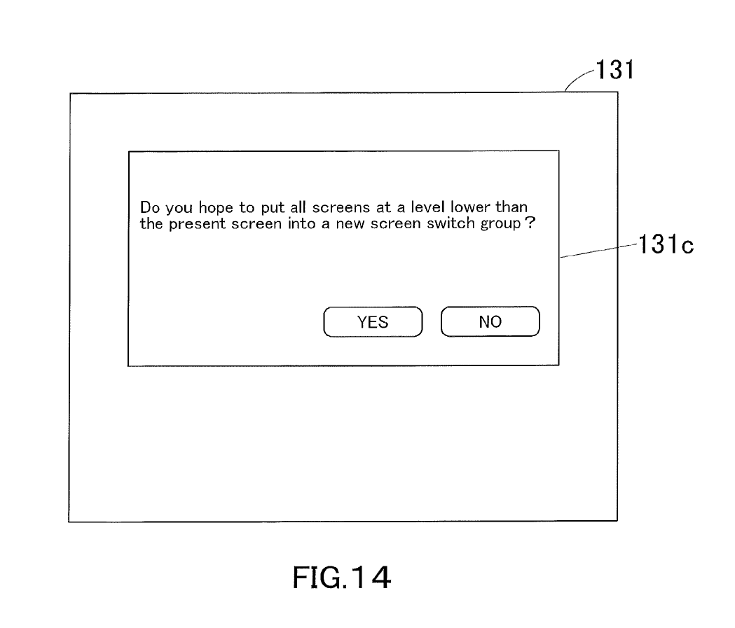

The screen switch group G2 can be created at a level lower than the screen switch group G1 as described below. For example, users create the screen switch group G2 by pressing a “YES” button in response to the message “do you hope to put all screens at a level lower than the present screen into a new screen switch group?” on the screen illustrated in FIG. 14.

The screen for creating the screen switch group G2 is not limited to a particular screen belonging to the screen switch group G1. Users may also create the screen switch group G1.

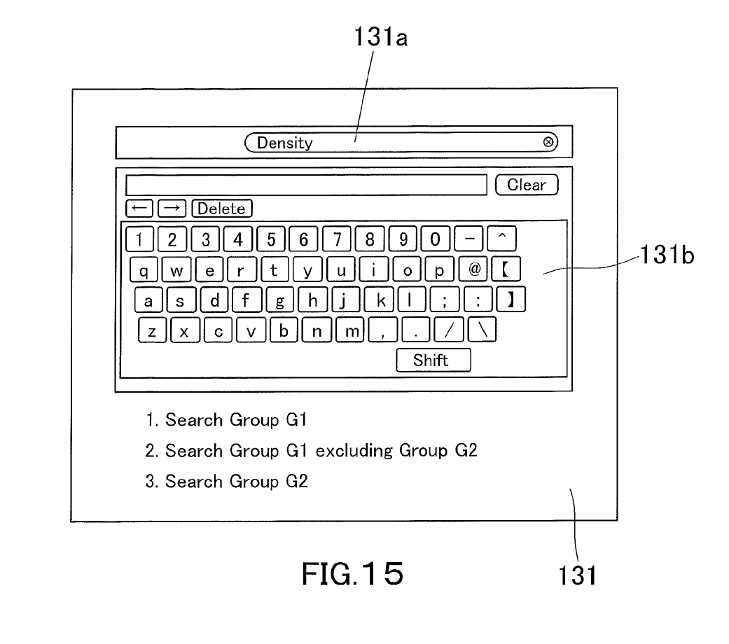

In a case where the screen switch group G2 is created as described above, it is preferred that users be allowed to specify a screen switch group as a search target. In this embodiment, users are allowed to select a search target from the following options with a touch gesture on a search screen having a search box 131a and a software keyboard 131b as illustrated in FIG. 15: the screen switch group G1, the screen switch group G1 excluding the screen switch group G2, and the screen switch group G2.

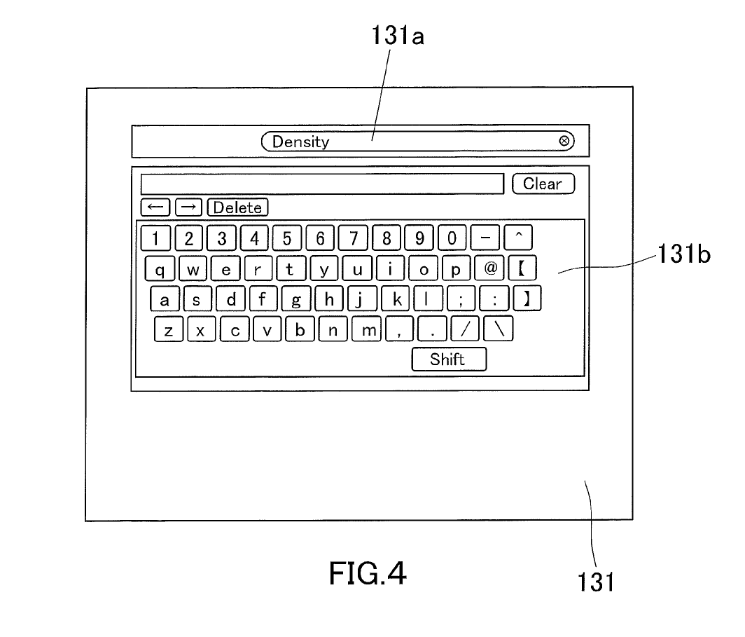

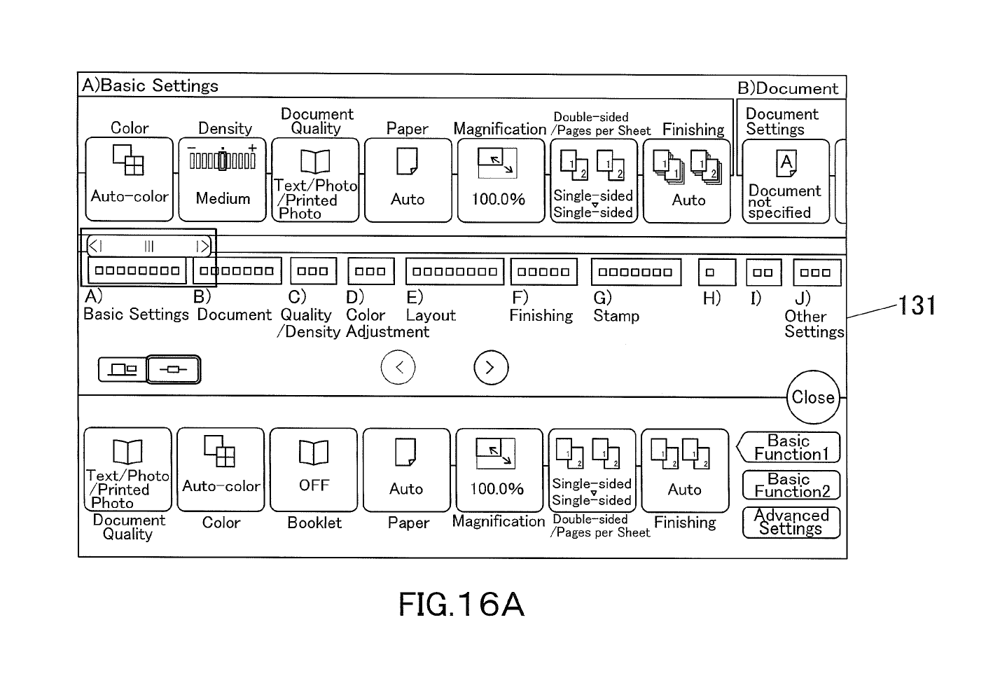

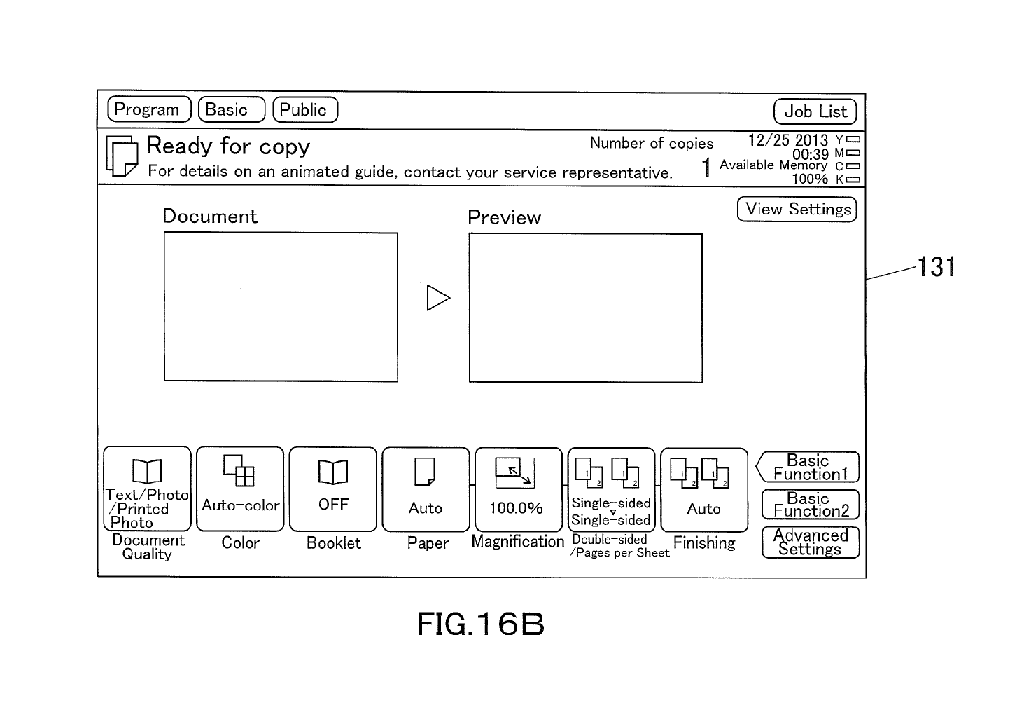

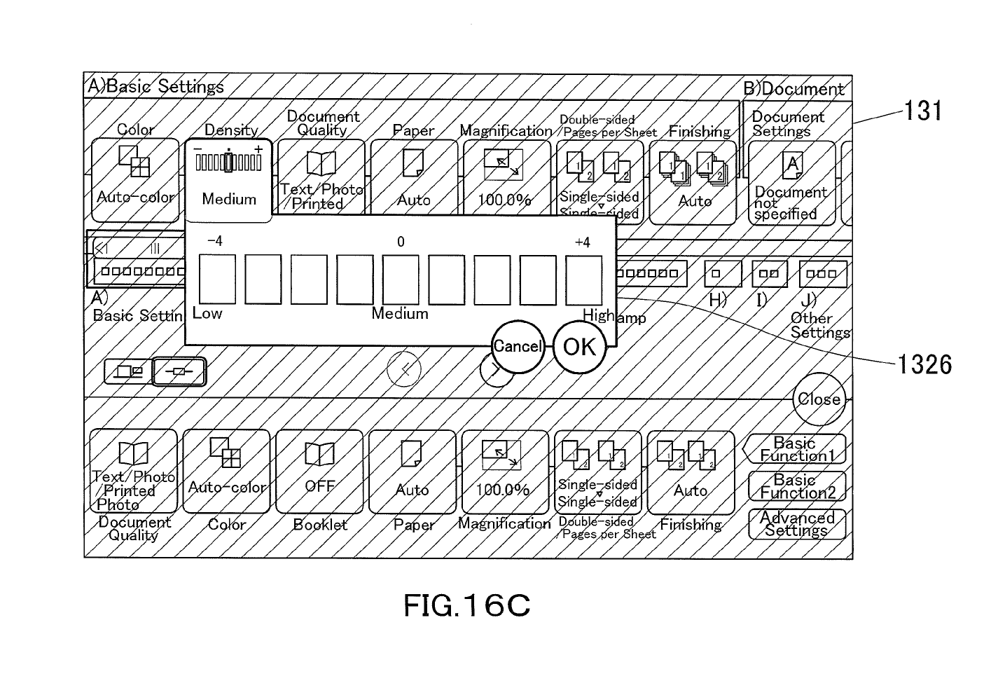

Users, especially who are unfamiliar with this field, may go from one screen to another to be lost with a screen at a very low level. As a solution to this, in this embodiment, the following two modes are installed: a mode for displaying a settings screen on the display 131 quickly upon a setting option being selected by a user and a mode for displaying an intended screen 1326 by automatically switching from one screen to another in descending order of level, e.g., in order of the screens illustrated in FIGS. 16A, 16B, and 16C. Users are allowed to select one of these modes on the search screen of FIG. 4 or FIG. 15, for example, which will contribute to the user-friendliness.

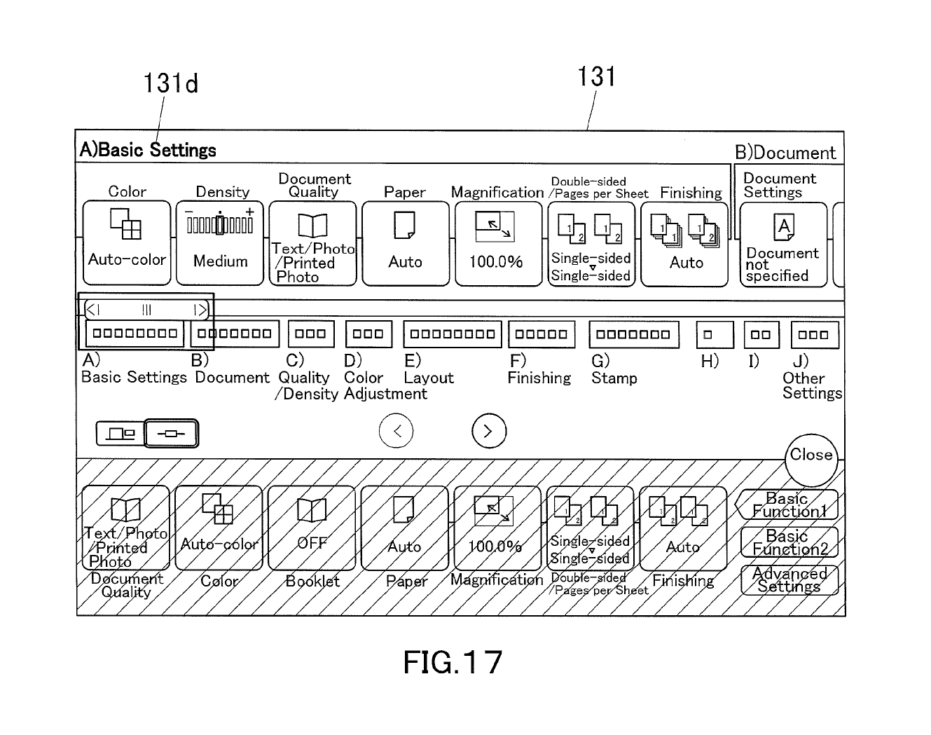

Furthermore, there is a possibility that users may hardly identify the present screen because of a plurality of strings representing setting options, which are obtained by search and displayed thereon. As a solution, in this embodiment, when a user goes to a settings screen by selecting a setting option, a string representing the selected setting option is displayed in a highlighted manner thereon. This will eliminate the possibility that users may hardly identify the present screen. In the example of FIG. 17, the string “basic settings” is displayed in a highlighted manner, e.g., by thick lines. The highlighted manner is not limited to this example; a string representing the selected setting option may be displayed in an enlarged size, in a different lightness, or in a different color.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image processing apparatus comprising:
a display; and
one or a plurality of processors that executes:
determining one of a plurality of screen switch groups as a search target based on a screen being displayed when a user gives instructions to search, the plurality of screen switch groups each being composed of a plurality of multi-level screens, the multi-level screens to be displayed on the display;
obtaining strings by searching the determined screen switch group, the strings each having a keyword specified by the user, the strings representing setting options to be set on the multi-level screens, the multi-level screens composing the determined screen switch group; and
displaying the setting options on the display in a manner allowing the user to select one of the setting options, the setting options being represented by the obtained strings, and then displaying a screen for setting one of the setting options upon the one setting option being selected by the user.

2. The image processing apparatus as recited in claim 1, wherein the plurality of processors are provided for the plurality of screen switch groups, respectively, and one of the processor obtains the strings by searching the determined screen switch group, the one processor corresponding to the determined screen switch group.

3. The image processing apparatus as recited in claim 1, wherein the one processor is a common processor provided for the plurality of screen switch groups and the one processor obtains the strings by searching the determined screen switch group.

4. The image processing apparatus as recited in claim 1, wherein, in a case where a function having setting options represented by the strings is prohibited from being displayed or used, the one or more processors allows the user to make settings such that the strings representing the setting options of the prohibited function will or will not be obtained by search.

5. The image processing apparatus as recited in claim 4, wherein, in a case where the user makes settings such that the strings representing the setting options of the prohibited function will be obtained by search and then selects one of the setting options displayed on the display, the setting options being represented by the strings, the strings being obtained by the one or plurality of processors, the one or plurality of processors displays a settings screen for removing the prohibition against the display or use of the prohibited function.

6. The image processing apparatus as recited in claim 1, wherein, in a case where a function having setting options represented by the string is prohibited from being displayed or used, by a specific user having power, the one or plurality of processors do not obtain the strings by search or do not display the strings as search results, the strings representing the setting options of the prohibited function.

7. The image processing apparatus as recited in claim 1, wherein the one or plurality of processors create the screen switch groups as instructed by the user.

8. The image processing apparatus as recited in claim 7, wherein:
the one or plurality of processors is capable of creating a second switch group at a level lower than a first switch group, the first switch group being composed of a plurality of multi-level screens, the second switch group being composed of more than one of the plurality of multi-level screens; and
the one or plurality of processors select a search target from the following options: the first screen switch group, the first screen switch group excluding the second screen switch group, and the second screen switch group.

9. The image processing apparatus as recited in claim 1, wherein the one or plurality of processors allows users to select one of the following options: displaying one of the multi-level screens on the display directly or displaying one of the multi-level screens on the display by switching from one screen to another in descending order of level, the one screen for setting one of the setting options, the one setting option being selected by the user.

10. The image processing apparatus as recited in claim 1, wherein the one or plurality of processors display one of the strings in a highlighted manner on one of the multi-level screens, the one string representing one of the setting options, the one setting option being selected by the user, the one screen for setting the one setting option.

11. A screen display method for an image processing apparatus comprising one or a plurality of processors that execute:
determining one of a plurality of screen switch groups as a search target based on a screen being displayed when a user gives instructions to search, the plurality of screen switch groups each being composed of a plurality of multi-level screens, the multi-level screens to be displayed on the display;
obtaining strings by searching the determined screen switch group, the strings each having a keyword specified by the user, the strings representing setting options to be set on the multi-level screens, the multi-level screens composing the determined screen switch group; and
displaying the setting options on the display in a manner allowing the user to select one of the setting options, the setting options being represented by the obtained strings, and then displaying a screen for setting one of the setting options upon the one setting option being selected by the user.

12. A non-transitory computer-readable recording medium storing a screen display program for a computer of an image processing apparatus comprising a display, the screen display program making the computer execute:
determining one of a plurality of screen switch groups as a search target based on a screen being displayed when a user gives instructions to search, the plurality of screen switch groups each being composed of a plurality of multi-level screens, the multi-level screens to be displayed on the display;
obtaining strings by searching the determined screen switch group, the strings each having a keyword specified by the user, the strings representing setting options to be set on the multi-level screens, the multi-level screens composing the determined screen switch group; and
displaying the setting options on the display in a manner allowing the user to select one of the setting options, the setting options being represented by the obtained strings, and then displaying a screen for setting one of the setting options upon the one setting option being selected by the user.
